(19) United States
(12) Patent Application Publication
(10) Pub. No.: US 2025/0171100 A1
(43) Pub. Date: May 29, 2025

(54) Method for Adjusting a Downforce of a Tilting Vehicle When Cornering and Tilting Vehicle

(71) Applicant: Bayerische Motoren Werke Aktiengesellschaft, Muenchen (DE)

(72) Inventor: Simon SCHMITT, Schoefweg (DE)

(21) Appl. No.: 18/859,599

(22) PCT Filed: Jun. 28, 2023
(86) PCT No.: PCT/EP2023/067607

§ 371 Date: Oct. 24, 2024

(30) Foreign Application Priority Data
Jul. 25, 2022 (DE) 10 2022 118 511.7

(51) Int. Cl. B62J 17/10

(52) U.S. Cl. CPC B62J 17/10

(57) ABSTRACT

A method for adjusting a downforce of a tilting vehicle when cornering, wherein the tilting vehicle comprises at least one load-bearing support structure and at least one aerodynamically effective profile device. The profile device comprises at least one aerodynamically effective profile body which is disposed on the support structure of the tilting vehicle, around which ambient air flows transversely to its longitudinal direction when the tilting vehicle moves, and which is fixed, by way of a bearing unit, on the support structure so as to be rotatable or pivotable about an axis of rotation extending in parallel with or obliquely to the longitudinal axis of the tilting vehicle, and by way of which, when ambient air flows around the body, a downforce can be generated and transferred to the support structure.

### BACKGROUND AND SUMMARY

This disclosure relates to a method for adjusting a downforce of a tilting vehicle when cornering and a tilting vehicle which can be operated with such a method.

Tilting vehicles are known from the prior art, wherein so-called winglets are arranged on the support structure of the tilting vehicle. These winglets are aerodynamically effective and increase a downforce of the tilting vehicle in the direction of the travel surface as the vehicle speed of the tilting vehicle increases. The tilting vehicle is thereby pressed with increasing force in the direction toward the travel surface.

The increase of the downforce has been found to be advantageous particularly when the tilting vehicle is cornering since grip and the stability of the tilting vehicle when cornering can be increased. The winglets known from the prior art are rigidly secured to the support structure. In the event of an inclination of the tilting vehicle with respect to a perpendicular, particularly when cornering, the downforce produced by the winglets and transmitted to the support structure is thereby reduced in the direction of the travel surface.

An object of an exemplary embodiment of the disclosure is to provide a method for adjusting a downforce of a tilting vehicle when cornering and a tilting vehicle which can be operated in accordance with such a method, by way of which a downforce, particularly when travelling round bends, can be adapted in an improved manner.

This object is achieved by a method for adjusting a downforce of a tilting vehicle when cornering, wherein the tilting vehicle has at least one load-bearing support structure and at least one aerodynamically effective profile apparatus, wherein the profile apparatus comprises at least one aerodynamically effective profile body which is arranged on the support structure of the tilting vehicle and around which ambient air flows transversely relative to the longitudinal direction thereof when the tilting vehicle moves, and which is fixed to the support structure by way of a bearing unit so as to be able to be rotated or pivoted about a rotation axis which extends parallel or obliquely relative to the longitudinal axis of the tilting vehicle and by way of which, when ambient air flows around, a downforce can be produced and transmitted to the support structure, and wherein the profile apparatus comprises at least one adjustment device, by way of which the profile body can be rotated or pivoted relative to the support structure about the rotation axis in order to adjust an angle between the longitudinal direction of the profile body and a horizontal and can be fixed.

The method has steps of:
a. detecting a tilting movement of the tilting vehicle in a tilting direction and detecting a tilting angle between the vertical axis of the tilting vehicle and a perpendicular by way of the adjustment device; and,
b. rotating or pivoting the at least one profile body by way of the adjustment device about the rotation axis in a rotation direction counter to the tilting direction when the detected tilting angle reaches or exceeds a specific tilting angle which is or can be stored in the adjustment device.

As a result of the fact that the profile apparatus comprises at least one aerodynamic profile body which is arranged on the support structure of the tilting vehicle and which can be rotated relative to the rotation axis, the profile body can be adjusted when cornering, that is to say, when the tilting vehicle is inclined with the vertical axis thereof with respect to the perpendicular. It can thereby be ensured that the downforce which is produced by the profile body and which is transmitted to the support structure is increased in comparison with tilting vehicles with profile bodies which are rigidly arranged thereon.

As a result of the fact that the at least one profile body is rotated by the adjustment device about the rotation axis in a rotation direction counter to the tilting direction, the profile body is rotated in a counter-clockwise direction about the rotation axis when the tilting vehicle carries out a rotation in the clockwise direction. Conversely, the profile body carries out a rotation in the clockwise direction when the tilting direction extends in a counter-clockwise direction.

As a result of the fact that the rotation or pivoting of the at least one profile body is carried out only when the specific tilting angle is reached or exceeded, the method can be carried out in an energy-efficient manner and can be carried out only from travel round bends with relatively great tilting.

The specific tilting angle may be 0°. In such a case, a control of the profile bodies takes place directly with the tilting of the tilting vehicle.

Furthermore, the specific tilting angle may be 10°, in particular 20°, in particular 30°.

The adjustment device and the bearing unit may form a common one-piece component. In such a case, the profile body is connected to the bearing unit in a rotationally secure manner and the bearing unit can be rotated via a controllable axle which can be rotated about the rotation axis by way of a drive and can be fixed in different angular positions.

The term “tilting vehicle” is in particular intended to be understood to mean bicycles, motorcycles or motorcycle-like motor vehicles, such as motor scooters, in particular two-wheeled, three-wheeled or four-wheeled motor scooters, scooters, tiltable trikes, quad-bikes or the like.

As a result of the fact that the at least one profile body can be rotated by the adjustment device about the rotation axis, it has been found to be advantageous for the at least one profile body with a substantially parallel arrangement of the vertical axis of the tilting vehicle with respect to the perpendicular to be able to be arranged in a basic position, in which the angle between the longitudinal direction of the profile body and the horizontal defines a basic position angle, and for the at least one profile body with an inclined arrangement of the vertical axis of the tilting vehicle with respect to the perpendicular to be able to be arranged in a tilting position, in which the angle between the longitudinal direction of the profile body and the horizontal defines a tilting position angle which with respect to the basic position angle is offset by the rotation or pivoting about the rotation axis in the rotation direction counter to the tilting direction.

As a result of the fact that the profile body, when the tilting vehicle is travelling in a straight line, that is to say, with a substantially parallel arrangement of the vertical axis of the tilting vehicle with respect to the perpendicular, can be arranged at a basic position angle and, when the tilting vehicle is cornering, can be arranged at a tilting position angle, the profile body can always be arranged in a state adapted to the respective driving maneuver.

In a further development of the last embodiment mentioned, it has been found to be advantageous for the basic position angle to substantially include 0° or for the basic position angle to include a low drag angle which is adjusted automatically or by the user and at which a downforce produced by the profile body is reduced with respect to a basic position angle of 0°.

If the basic position angle is substantially 0°, the profile body is arranged so as to extend substantially parallel with the horizontal. The downforce produced by the profile body can thereby be at a maximum.

When the profile body can be arranged with a low drag angle as a basic position angle, this may include an angle at which the profile body even when the tilting vehicle is travelling straight ahead produces a lower downforce than would be possible with a basic position angle of 0°. The tilting vehicle can thereby be adapted to different travel situations in which less downforce is desirable.

If the basic position angle includes an automatically adjusted low drag angle, this may be selected, for example, in accordance with the travel speed. The low drag angle can thus be adapted at relatively high speed increasingly to an angle of 0° and at relatively low speeds can deviate increasingly from 0°.

Furthermore, a further development of the method makes provision for the tilting position angle:
a. to be offset with respect to the basic position angle by the tilting angle as a result of the rotation or pivoting about the rotation axis in the rotation direction counter to the tilting direction when the tilting angle is smaller than the specific tilting angle,
b. to be offset with respect to the basic position angle by the difference from the tilting angle and specific tilting angle as a result of the rotation or pivoting about the rotation axis in the rotation direction counter to the tilting direction when the tilting angle is greater than the specific tilting angle, or
c. to be offset with respect to the basic position angle by the tilting angle as a result of the rotation or pivoting about the rotation axis in the rotation direction counter to the tilting direction when the tilting angle is greater than the specific tilting angle and in particular includes 0° with respect to the horizontal.

If the tilting angle is smaller than the specific tilting angle, the profile body remains positioned in a rigid and fixed manner with respect to the tilting vehicle.

When the tilting angle is greater than the specific tilting angle, the profile body can in such cases in case b. (above) rotate only by the value of the difference of the tilting angle and specific tilting angle or rotate through the entire tilting angle in accordance with case c. (above).

In case c. (above), the tilting position angle is 0° when the basic position angle includes 0°.

The adaptation of the tilting position angle can be carried out in a single step or continuously in several steps.

When the tilting position angle includes the sum of the basic position angle and the tilting angle of the tilting vehicle in the rotation direction counter to the tilting direction, it can be ensured that the arrangement of the profile body is always identical with respect to an underlying surface. When the tilting position angle includes substantially 0°, the profile body is arranged substantially parallel with a horizontal, even when the tilting vehicle is travelling round bends.

Furthermore, an adjustment of the downforce produced by the at least one profile body can be further improved when the method involves a rotation or pivoting of the at least one profile body by the adjustment device about a rotation axis which extends parallel or obliquely with respect to the transverse axis of the tilting vehicle by the adjustment device in order to adjust an angle of attack.

As a result of the fact that the angle of attack can be adjusted, a downforce which can be produced by the profile body can be adjusted.

In principle, it is conceivable that a profile body is arranged on the tilting vehicle only at one side. In order to increase the stability of the tilting vehicle during operation and/or in order to increase the downforces which are transmitted to the tilting vehicle, however, it has been found to be advantageous for the profile apparatus to comprise at least two aerodynamically effective profile bodies which are arranged on the support structure of the tilting vehicle and which are flowed around by ambient air transversely to the longitudinal direction thereof when the tilting vehicle moves.

As a result of the fact that at least two profile bodies are provided, the method can be further improved.

In a further development of the last embodiment mentioned, exemplary embodiments may be provided in which at least two of the at least two profile bodies are arranged in a mirror-symmetrical manner relative to each other with respect to a plane through the longitudinal axis and the vertical axis of the tilting vehicle and/or in which at least two of the at least two profile bodies are arranged offset relative to each other with respect to a plane through the longitudinal axis and the vertical axis of the tilting vehicle in the longitudinal direction of the tilting vehicle.

When the at least two profile bodies are arranged in a mirror-symmetrical manner with respect to the vehicle center, the tilting vehicle is stabilized in particular when driving in a straight line. Furthermore, the at least two profile bodies may be arranged at the same vehicle side in order to be offset relative to each other with respect to the longitudinal axis. For example, embodiments are thereby conceivable in which one profile body is arranged on a front wheel of the tilting vehicle and one profile body is arranged on a rear wheel of the tilting vehicle.

Furthermore, it has been found to be advantageous when the at least two profile bodies can be controlled by the adjustment device together or independently of each other with respect to their basic position angle, tilting position angle and/or the angle of attack.

When the at least two profile bodies can be controlled by the adjustment device together with respect to their basic position angle, tilting position angle and/or the angle of attack, with respect to the longitudinal axis of the tilting vehicle at both sides a force equilibrium of the downforces can be produced. When the at least two profile bodies can be adjusted independently of each other, by controlling the profile bodies different travel situations can be configured in an optimized manner.

Furthermore, the object is achieved by a tilting vehicle which can be operated in accordance with a method having the above-mentioned features, having at least one load-bearing support structure and having at least one aerodynamically effective profile apparatus which comprises at least one aerodynamically effective profile body which is arranged on the support structure of the tilting vehicle and which is flowed around by ambient air transversely relative to the longitudinal direction thereof when the tilting vehicle moves, and which is secured to the support structure by way of a bearing unit so as to be able to be rotated or pivoted about a rotation axis which extends parallel or obliquely with respect to the longitudinal axis of the tilting vehicle and by way of which a downforce can be produced and transmitted to the support structure when ambient air flows around, and which comprises at least one adjustment device, by way of which the profile body can be rotated or pivoted relative to the support structure about the rotation axis in order to adjust an angle between the longitudinal direction of the profile body and a horizontal and can be fixed.

Finally, it has been found to be advantageous for at least one of the at least one profile bodies to comprise a winglet.

The winglet may, for example, be arranged on a support structure which is in the form of a vehicle frame. Furthermore, embodiments of the tilting vehicle are conceivable in which the at least one profile body is arranged on a front wheel and/or on a rear wheel.

### BRIEF SUMMARY OF THE DRAWINGS

Other features, details and advantages of the disclosure will be appreciated from the illustrations and the following description of a preferred embodiment of the tilting vehicle and the method.

FIG. 1 shows a front view of a tilting vehicle having a profile apparatus when the tilting vehicle is travelling in a straight line;

FIG. 2 shows a front view of a tilting vehicle having a profile apparatus when the tilting vehicle is travelling round bends; and,

FIG. 3 shows a schematic flow chart of the method according to the disclosure.

### DETAILED DESCRIPTION OF THE DRAWINGS

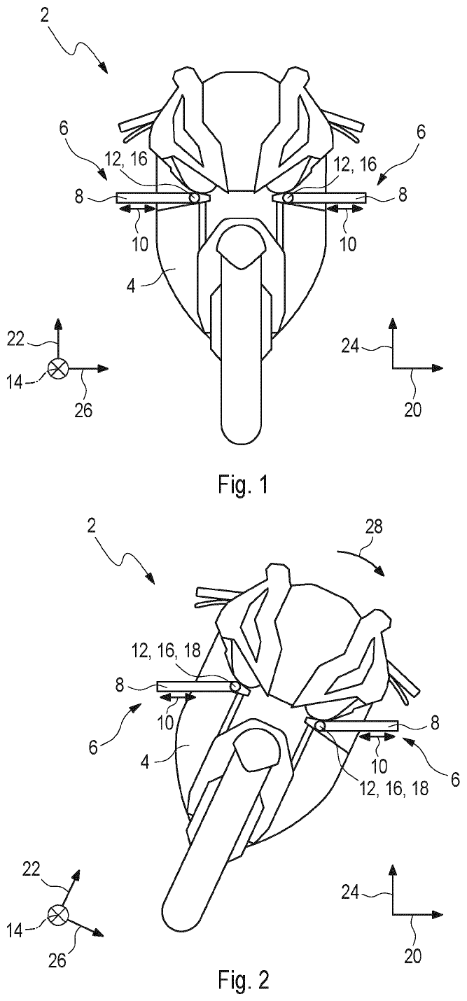

FIGS. 1 and 2 show a first exemplary embodiment of a tilting vehicle which is generally designated 2. The tilting vehicle 2 comprises a load-bearing structure 4 and at least one aerodynamically active profile apparatus 6.

In the exemplary embodiment of the tilting vehicle 2 as shown in FIGS. 1 and 2, the profile apparatus 6 comprises two aerodynamically effective profile bodies 8. These are flowed around by ambient air transversely relative to the longitudinal direction 10 thereof when the tilting vehicle 2 moves. The profile apparatus 6 comprises bearing units 12 which are secured to the support structure 4 and on which in each case a profile body 8 can be rotated about a rotation axis 16 which extends parallel with the longitudinal axis 14 of the tilting vehicle 2.

Furthermore, the tilting vehicle 2 comprises an adjustment device 18 by way of which the profile bodies 8 can be secured relative to the support structure 4 so as to be able to be rotated or pivoted about the rotation axis 16 in order to adjust an angle between the longitudinal direction 10 of the profile body 8 and a horizontal 20.

FIG. 1 shows the tilting vehicle 2 when travelling in a straight line. In this instance, a vertical axis 22 of the tilting vehicle 2 is arranged parallel with a perpendicular 24. The transverse axis 26 of the tilting vehicle 2 is in this instance at a right-angle with respect to the vertical axis 22 of the tilting vehicle 2.

In the exemplary embodiment of the tilting vehicle 2 as shown in FIG. 1, the profile bodies 8 are arranged in a basic position in which an angle between the longitudinal direction 10 of the profile body 8 and the horizontal 20 is at least virtually 0°. A downforce which can be produced by the profile bodies 8 is in this instance at a maximum.

FIG. 2 shows the tilting vehicle 2 during travel round bends. In this instance, the vertical axis 22 of the tilting vehicle 2 is tilted with respect to the perpendicular 24. As a result of the adjustment device 18, the profile bodies 8 are rotated in a direction counter to the tilting direction 28 of the tilting vehicle 2 and are located at a tilting position angle which is defined as the angle between the longitudinal direction 10 of the profile body 8 and the horizontal 20. During travel round bends, the angle between the longitudinal direction 10 of the profile body 8, that is to say, the tilting position angle, also includes 0°.

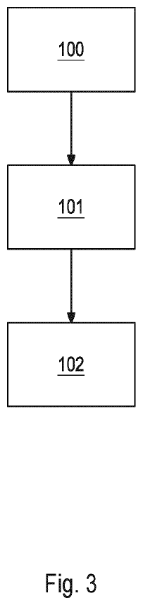

FIG. 3 shows a schematic flow chart of a method according to disclosure by way of which the tilting vehicle 2 can be operated. With the aid of the illustration of FIGS. 1 and 2, the method will be described below.

In a first step 100, the tilting vehicle 2 is travelling in a straight line. In this instance, the profile bodies 8 are controlled in such a manner by the adjustment device 18 that the profile bodies 8 are located with the longitudinal directions 10 thereof substantially parallel with the horizontal 20. Furthermore, in the step 100 via the adjustment device 18 a basic position angle which deviates from 0° can be adjusted. This may, for example, be the case when no maximum possible downforce is intended to be produced by the profile body 8.

Furthermore, in the step 100, it is made possible for the profile bodies 8 to be able to be rotated about a rotation axis 16 which extends parallel with the transverse axis 26 of the tilting vehicle 2, whereby an angle of attack of the profile body 8 with respect to the surrounding flow can be adjusted.

In a step 101, a tilting movement of the tilting vehicle 2 in the tilting direction 28 is detected and a tilting angle between the vertical axis 22 of the filting vehicle 2 and the perpendicular is detected.

In a step 102, the profile bodies 8 are rotated or pivoted by the adjustment device 18 about the respective rotation axis 16 thereof when the detected tilting angle reaches or exceeds a specific tilting angle which is or can be stored in the adjustment device 18, with a direction of rotation counter to the tilting direction 28.

In this instance, the profile bodies 8 may include a tilting position angle which includes substantially 0° with respect to the horizontal 20.

The adjustment device 18 may comprise a controller (e.g., a processor, a microprocessor, a CPU, etc.) along with a storage (e.g., a memory, RAM, ROM, etc.) for storing software, logic, data, or the like. The adjustment device 18 may be associated with a traditional engine control unit (ECU), an engine control module (ECM), a motor control unit (MCU), or a body control module (BCM). They adjustment device 18 may further comprise one or more mechanical or electrical actuators to move the profile bodies 8.

The features of the disclosure which are disclosed in the above description, in the claims and in the drawings may be significant both individually and in any combination when carrying out the disclosure in its various embodiments in the context of the protective scope of the following claims.

### LIST OF REFERENCE NUMERALS

2 Tilting vehicle
4 Support structure
6 Profile apparatus
8 Profile body
10 Longitudinal direction
12 Bearing unit
14 Longitudinal axis
16 Rotation axis
18 Adjustment device
20 Horizontal
22 Vertical axis
24 Perpendicular
26 Transverse axis
28 Tilting direction
100-102 Method steps

1-10. (canceled)

11. A method for adjusting a downforce of a tilting vehicle when cornering, wherein the tilting vehicle comprises at least one load-bearing support structure and at least one aerodynamically effective profile apparatus, wherein the profile apparatus comprises at least one aerodynamically effective profile body which is arranged on the support structure of the tilting vehicle and around which ambient air flows transversely relative to the longitudinal direction thereof when the tilting vehicle moves, and which is fixed to the support structure by way of a bearing unit so as to be able to be rotated or pivoted about a rotation axis which extends parallel or obliquely relative to the longitudinal axis of the tilting vehicle and by way of which, when ambient air flows around, a downforce can be produced and transmitted to the support structure, and wherein the profile apparatus comprises at least one adjustment device, by way of which the profile body can be rotated or pivoted relative to the support structure about the rotation axis in order to adjust an angle between the longitudinal direction of the profile body and a horizontal and can be fixed, the method having the steps of:
a. detecting a tilting movement of the tilting vehicle in a tilting direction and detecting a tilting angle between the vertical axis of the tilting vehicle and a perpendicular by way of the adjustment device;
b. rotating or pivoting the at least one profile body by way of the adjustment device about the rotation axis in a rotation direction counter to the tilting direction when the detected filting angle reaches or exceeds a specific tilting angle which is or can be stored in the adjustment device.

12. The method according to claim 11, wherein the at least one profile body with a substantially parallel arrangement of the vertical axis of the tilting vehicle with respect to the perpendicular can be arranged in a basic position, in which the angle between the longitudinal direction of the profile body and the horizontal defines a basic position angle, and wherein the at least one profile body with an inclined arrangement of the vertical axis of the tilting vehicle with respect to the perpendicular can be arranged in a tilting position, in which the angle between the longitudinal direction of the profile body and the horizontal defines a tilting position angle which with respect to the basic position angle is offset by the rotation or pivoting about the rotation axis in the rotation direction counter to the tilting direction.

13. The method according to claim 12, wherein the basic position angle substantially includes 0° or the basic position angle includes a low drag angle which is adjusted automatically or by the user and at which a downforce produced by the profile body is reduced with respect to a basic position angle of 0°.

14. The method according to claim 12, wherein the tilting position angle is:
offset with respect to the basic position angle by the tilting angle as a result of the rotation or pivoting about the rotation axis in the rotation direction counter to the tilting direction when the tilting angle is smaller than the specific tilting angle,
offset with respect to the basic position angle by the difference from the tilting angle and specific tilting angle as a result of the rotation or pivoting about the rotation axis in the rotation direction counter to the tilting direction when the tilting angle is greater than the specific tilting angle, or
offset with respect to the basic position angle by the tilting angle as a result of the rotation or pivoting about the rotation axis in the rotation direction counter to the tilting direction when the tilting angle is greater than the specific tilting angle and in particular includes 0° with respect to the horizontal.

15. The method according to claim 11, comprising a rotation or pivoting of the at least one profile body by the adjustment device about a rotation axis which extends parallel or obliquely with respect to the transverse axis of the tilting vehicle by the adjustment device in order to adjust an angle of attack which is defined by an angle between the transverse axis of the profile body and horizontal.

16. The method according to claim 11, wherein the profile apparatus comprises at least two aerodynamically effective profile bodies which are arranged on the support structure of the tilting vehicle and which are flowed around by ambient air transversely to the longitudinal direction thereof when the tilting vehicle moves.

17. The method according to claim 16, wherein at least two of the at least two profile bodies are arranged in a mirror-symmetrical manner relative to each other with respect to a plane through the longitudinal axis and the vertical axis of the tilting vehicle and/or in that at least two of the at least two profile bodies are arranged offset relative to each other with respect to a plane through the longitudinal axis and the vertical axis of the tilting vehicle in the longitudinal direction of the tilting vehicle.

18. The method according to claim 16, wherein the at least two profile bodies can be controlled by the adjustment device together or independently of each other with respect to their basic position angle, tilting position angle and/or the angle of attack.

19. A tilting vehicle which can be operated in accordance with the method of claim 11, comprising at least one load-bearing support structure and having at least one aerodynamically effective profile apparatus which comprises at least one aerodynamically effective profile body which is arranged on the support structure of the tilting vehicle and which is flowed around by ambient air transversely relative to the longitudinal direction thereof when the tilting vehicle moves, and which is secured to the support structure by way of a bearing unit so as to be able to be rotated or pivoted about a rotation axis which extends parallel or obliquely with respect to the longitudinal axis of the tilting vehicle and by way of which a downforce can be produced and transmitted to the support structure when ambient air flows around, and which comprises at least one adjustment device, by way of which the profile body can be rotated or pivoted relative to the support structure about the rotation axis in order to adjust an angle between the longitudinal direction of the profile body and a horizontal and can be fixed.

20. The tilting vehicle according to claim 19, wherein at least one of the at least one profile bodies comprises a winglet.
